(19) United States
(12) Patent Application Publication
(10) Pub. No.: US 2025/0069119 A1
(43) Pub. Date: Feb. 27, 2025

(54) System and Method for Advertisement Management and Filtering

(71) Applicant: Ryan Fowles, Sterling, UT (US)

(72) Inventor: Ryan Fowles, Sterling, UT (US)

(21) Appl. No.: 18/804,591

(22) Filed: Aug. 14, 2024

Related U.S. Application Data
(60) Provisional application No. 63/578,056, filed on Aug. 22, 2023.

(51) Int. Cl. G06Q 30/0251; G06F 21/31

(52) U.S. Cl. CPC G06Q 30/0271; G06F 21/31

(57) ABSTRACT

An advertisement management and filtering system and includes a user advertisement filter application installed on user devices and an advertiser advertisement filter application installed on advertiser devices is disclosed. The server system comprises a user management module, an advertisement management system with an advertisement database, and a targeting engine for matching ads to user profiles based on preferences. An API module facilitates communication between user and advertiser applications and external platforms. The method includes receiving user ad preferences, syncing them across multiple platforms, receiving and categorizing ads from advertisers, and displaying matched ads to users. The system leverages machine learning for improved ad targeting and offers a comprehensive solution for personalized ad delivery, ensuring relevant advertisements reach the appropriate audience.

### CROSS-REFERENCE TO RELATED APPLICATION

The present application claims priority to, and the benefit of, U.S. Provisional Application No. 63/578,056, which was filed on Aug. 22, 2023 and is incorporated herein by reference in its entirety.

### FIELD OF THE INVENTION

The present invention generally relates to the field of digital advertising. More specifically, the present invention pertains to an advertisement management and filtering system for social media and streaming platforms. The system includes a user advertisement filter application for setting ad preferences and an advertiser application for managing ad content. A server system comprising a user management module, advertisement management system, and targeting engine ensures personalized ad delivery by matching ads to user profiles based on preferences. Accordingly, the present disclosure makes specific reference thereto. Nonetheless, it is to be appreciated that aspects of the present invention are also equally applicable to other like applications, devices, and methods of manufacture.

### BACKGROUND

By way of background, television shows, music, movies, and other media on streaming platforms include advertisements. The advertisements are often untargeted, leading to a frustrating user experience. Users may frequently receive ads that are irrelevant or uninteresting to them, which can significantly detract from their overall enjoyment of the content. Untargeted advertisements not only annoy users but can also result in reduced customer engagement. When faced with frequent ad breaks filled with irrelevant ads, users are more likely to become disengaged and may even abandon the platform altogether. The decreased engagement can have a negative impact on the streaming platform's user retention and overall satisfaction. Moreover, the lack of targeted advertising does not enable advertisers to effectively reach their intended audience, resulting in lower ad effectiveness and potential wasted ad expenditures. By providing a solution that enables users to filter and personalize the ads they receive, both user experience and ad effectiveness can be greatly improved.

Therefore, there exists a long-felt need in the art for an advertisement management and filtering system that enhances the user experience on social media and streaming platforms by enabling users to control the types of ads they receive. There is also a long-felt need in the art for a system that enables advertisers to effectively target their audience, improving ad relevance and engagement. Additionally, there is a long-felt need in the art for a solution that minimizes user frustration caused by irrelevant ads, thereby increasing customer retention and satisfaction. Moreover, there is a long-felt need in the art for an advertisement delivery system that leverages advanced technologies such as machine learning to continuously optimize ad targeting. Furthermore, there is a long-felt need in the art for an integrated platform that supports seamless communication between user preferences, advertiser inputs, and multiple streaming services to ensure a cohesive ad experience. Finally, there is a long-felt need in the art for a comprehensive ad management system that provides detailed analytics and insights for advertisers to refine their ad campaigns.

The subject matter disclosed and claimed herein, in one embodiment thereof, comprises an advertisement management and filtering system. The system includes a user advertisement filter application installed on user devices, such as smartphones or tablets, enabling users to set and manage their ad preferences. The system also includes an advertiser advertisement filter application installed on advertiser devices, enabling advertisers to upload, categorize, and manage their advertisements. The server system comprises a user management module, an advertisement management system with an advertisement database, and a targeting engine. The user management module stores user profiles, preferences, and demographic information. The advertisement management system includes a database for storing ads and a targeting engine that matches ads to user profiles based on preferences. Additionally, an Application Programming Interface (API) module facilitates communication between the user and advertiser applications and external platforms, ensuring synchronized and relevant ad delivery.

In this manner, the advertisement management and filtering system of the present invention accomplishes all of the foregoing objectives and provides a novel solution for personalized ad delivery. The system utilizes user and advertiser applications to manage preferences and ad content, respectively. The server system's user management module handles user profiles and preferences, while the advertisement management system stores ads and employs a targeting engine to ensure relevant ad matches. The API module ensures smooth communication between applications and streaming platforms, syncing preferences and displaying appropriate ads. By leveraging machine learning, the targeting engine continuously optimizes ad targeting, providing users with a personalized ad experience and advertisers with effective audience reach. The system enhances user satisfaction and engagement on streaming platforms, offering a sustainable and efficient solution for modern advertising challenges.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a system for managing and filtering advertisements. The system comprises a user advertisement filter application adapted to be installed on a user device, the application is configured to enable users to set preferences for advertisements they wish to see. An advertisement filter application is adapted to be installed on an advertiser device, the application is configured to enable advertisers to upload, categorize, and manage their advertisements. A server system includes a user management module for managing user profiles and preferences, an advertisement database for storing advertisements and associated metadata, a targeting engine for matching advertisements to user profiles based on user preferences and advertiser criteria, and an API module configured to facilitate communication between the user advertisement filter application, the advertiser advertisement filter application, and external platforms to sync and display relevant advertisements based on user preferences.

In yet another embodiment, a method for selecting and displaying advertisements to users based on their preferences is described. The method includes the steps of receiving, by a user advertisement filter application installed on a user device, preferences for advertisements from a user, storing the received preferences in a user database, syncing the stored preferences across multiple streaming and social media platforms via an API module, and displaying advertisements to the user on the streaming and social media platforms based on the stored preferences and user profile information.

In another aspect, a method for managing advertisements and displaying them to users based on their preferences is described. The method includes the steps of receiving user preferences for advertisements via a user advertisement filter application installed on a user device, storing the user preferences in a user database within a server system, receiving advertisements and target audience criteria from advertisers via an advertiser advertisement filter application installed on an advertiser device, storing the received advertisements and target audience criteria in an advertisement database within the server system, using a targeting engine to match the stored advertisements with user profiles based on the user preferences and advertiser criteria, syncing the matched advertisements across multiple streaming and social media platforms via an API module, and displaying the matched advertisements to the users on the streaming and social media platforms.

In still another aspect, a non-transitory computer-readable medium storing instructions that, when executed by a processor, cause a system to receive user preferences for advertisements through a user advertisement filter application installed on a user device, store the received preferences in a user database, sync the stored preferences with multiple streaming and social media platforms via an API module, receive advertisements and target audience criteria from advertisers through an advertiser advertisement filter application installed on an advertiser device, store the received advertisements and target audience criteria in an advertisement database, match the stored advertisements with user profiles based on the user preferences and advertiser criteria using a targeting engine, and display the matched advertisements to users on the streaming and social media platforms based on the user preferences and matched criteria.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of an advertisement management system of the present invention in accordance with the disclosed structure;

FIG. 2 illustrates an exemplary user interface displayed by the ad filter application of the present invention in accordance with the disclosed architecture;

FIG. 3 illustrates a user interface displayed by the user advertisement filter application in accordance with one embodiment of the present invention;

FIG. 4 illustrates another exemplary interface displayed by the user application of the present invention for applying preferences for advertisements in accordance with the disclosed structure;

FIG. 5 illustrates a perspective view showing selection of an advertisement category by a user and an advertisement corresponding to the category being displayed to the user in accordance with the disclosed architecture;

FIG. 6 illustrates a user interface displayed by the advertiser ad-filter application for enabling advertisers to manage advertisements in accordance with one embodiment of the present invention;

FIG. 7 illustrates an exemplary user interface displayed to an advertiser for selecting one or more streaming platforms or other social media platforms for selection in accordance with the disclosed structure;

FIG. 8 illustrates a flow chart depicting a process of displaying relevant ads to a user based on the preferences in accordance with one embodiment of the present invention; and

FIG. 9 illustrates a flow chart depicting a process of matching preferences of the users and advertisers to display relevant ads to customers in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an advertisement management and filtering system that enhances the user experience on social media and streaming platforms by enabling users to control the types of ads they receive. There is also a long-felt need in the art for a system that enables advertisers to effectively target their audience, improving ad relevance and engagement. Additionally, there is a long-felt need in the art for a solution that minimizes user frustration caused by irrelevant ads, thereby increasing customer retention and satisfaction. Moreover, there is a long-felt need in the art for an advertisement delivery system that leverages advanced technologies such as machine learning to continuously optimize ad targeting. Furthermore, there is a long-felt need in the art for an integrated platform that supports seamless communication between user preferences, advertiser inputs, and multiple streaming services to ensure a cohesive ad experience. Finally, there is a long-felt need in the art for a comprehensive ad management system that provides detailed analytics and insights for advertisers to refine their ad campaigns.

The present invention, in one exemplary embodiment, is a method for managing advertisements and displaying them to users based on their preferences. The method includes the steps of receiving user preferences for advertisements via a user advertisement filter application installed on a user device, storing the user preferences in a user database within a server system, receiving advertisements and target audience criteria from advertisers via an advertiser advertisement filter application installed on an advertiser device, storing the received advertisements and target audience criteria in an advertisement database within the server system, using a targeting engine to match the stored advertisements with user profiles based on the user preferences and advertiser criteria, syncing the matched advertisements across multiple streaming and social media platforms via an API module, and displaying the matched advertisements to the users on the streaming and social media platforms.

Reference will now be made in detail to the present preferred embodiments of the invention, examples of which are illustrated in the accompanying drawings. Wherever possible, the same reference numerals are used in the drawings and the description to refer to the same or like parts.

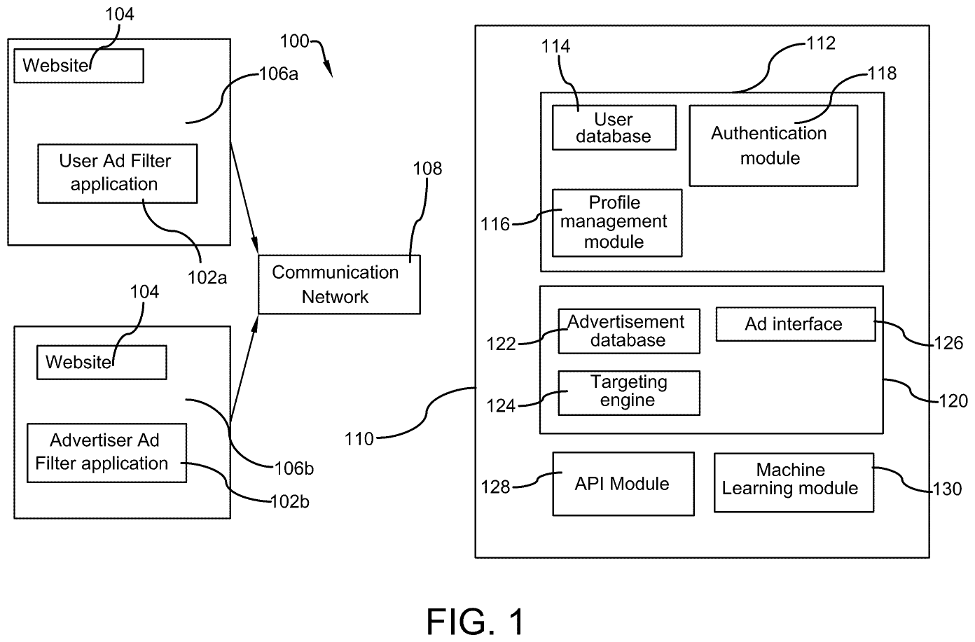

Referring initially to the drawings, FIG. 1 illustrates a schematic view of advertisements management system of the present invention in accordance with the disclosed structure. The advertisements management system 100 of the present invention is designed to enhance the advertising experience for users of social media and streaming services by enabling them to filter the ads they receive based on their preferences. More specifically, the system 100 includes a user advertisement filter application 102a which is adapted to be installed in a user device 106a such as a smartphone, tablet, computer, or any other similar device. A website 104 is also configured to provide the same functionality provided by the user application 102a. The user advertisement filter application 102a is preferably used by consumers of streaming services, e-sports services, and more to specify their ad preferences.

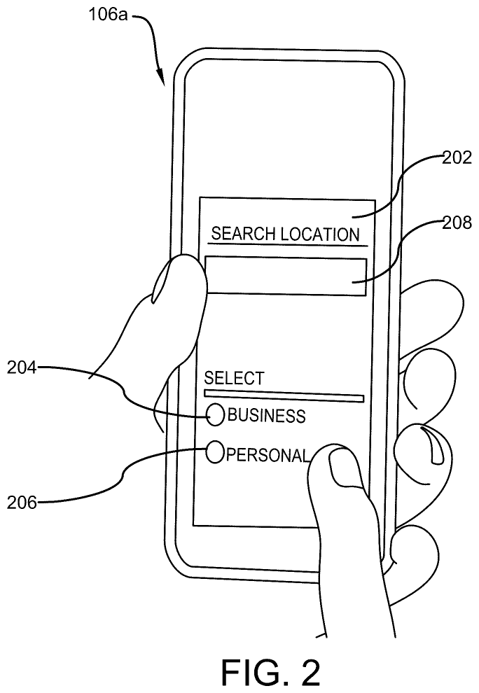

An advertiser ad-filter application 102b is installed in the device 106b of an advertiser wherein the website 104 can also provide the functionality provided by the advertiser ad-filter application 102b. It will be apparent to a person skilled in the art that the applications 102a, 102b are two different versions of the same application and are configured to provide different functionalities to the users (i.e., customers or consumers) and advertisers. The application can be customized based on customer or advertiser logging into the application as illustrated in FIG. 2.

The applications 102a, 102b are configured to provide functionalities offered by the server system 110 and the applications 102a, 102b access the functionalities using the communication network 108. The server 110 includes a user management module 112 for managing user information of the system 100. Specifically, the user management module 112 includes a user database 114 which stores user profiles, preferences, and demographic information of users and advertisers. A profile management module 116 enables users to update their preferences and profile information using the website 104 or the application 102a, 102b. The profile management module 116 also stores credential information of users. An authentication module 118 manages user login, registration, and authentication processes and compares the received credentials from the users to the stored credential information for authentication.

The server 110 also includes an advertisement management system 120. The advertisement management system 120 includes advertisement database 122, targeting engine 124, and advertisement interface 126. The ad database 122 is configured to store uploaded advertisements, corresponding metadata such as title, format, and more, and categorization information such as genre, age rating, and more. The targeting engine 124 is adapted to match ads to user profiles based on preferences and targeting criteria set by advertisers. The targeting engine 124 may use artificial intelligence to learn behavior and activities of the users to recommend the most relevant advertisement to them. For artificial intelligence, the targeting engine 124 may use machine learning module 130. The advertisement interface 126 enables advertisers to upload, categorize, and manage their ads to the system 100.

An API module 128 is adapted to include different APIs to facilitate communication between the user client application 102a and the server 110 for updating preferences, fetching personalized ads, and other user-related interactions. The API module 128 also enables advertisers to upload ads, set targeting criteria, and manage their ad campaigns. Some APIs in the API module 128 interfaces with social media and streaming services to communicate ad preferences of the users and deliver personalized ads to the users.

A machine learning module 130 uses a plurality of supervised and unsupervised machine learning algorithms to track past behavior, preferences, dislikes, and streaming pattern of the users to automatically recommend new advertisement categories for selection or for blocking. The targeting engine 124 coordinates with the machine learning module 130 for recommending relevant advertisements to the users of the system 100.

FIG. 2 illustrates an exemplary user interface displayed by the ad filter application of the present invention in accordance with the disclosed architecture. The interface 202 can be displayed by any of the applications 102a, 102b (herein after referred to as 102). An individual can select business 204 or personal use 206 for the system 100 to accordingly display different functionalities to the individual. When business 204 is selected then the application functions as the advertiser application 102b and when personal use 206 is selected, then the application functions as user application 102a. For providing relevant information, the individual can select a location 208 for enabling the system 100 to display information as per the local compliances.

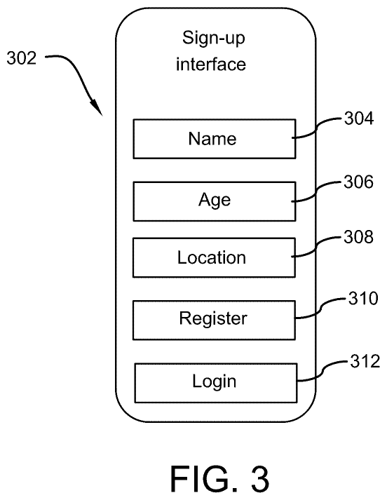

FIG. 3 illustrates a user interface displayed by the user advertisement filter application 102a in accordance with one embodiment of the present invention. The interface 302 is displayed by the application 102a and is used for signing up a user or customer of social media and streaming platforms. The interface 302 enables a user to input name 304, age 306, and location 308 while enabling the user to register to the application using the register button 310 and directly login using the Login button 312.

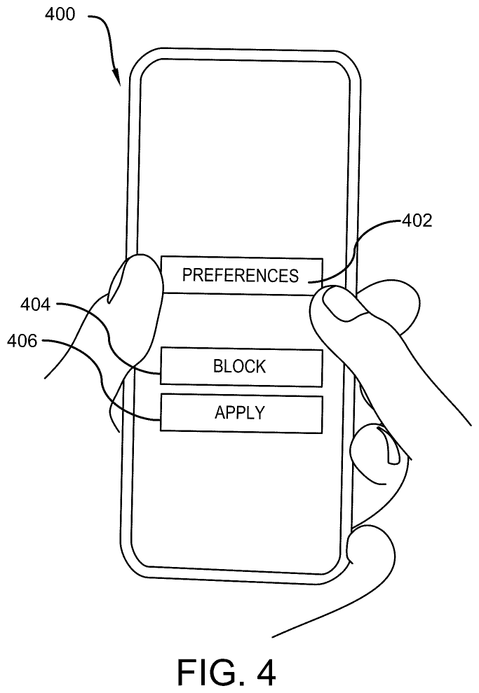

FIG. 4 illustrates another exemplary interface displayed by the user application of the present invention for applying preferences for advertisements in accordance with the disclosed structure. The interface 400 provides Preferences option 402 which enables a user to select one or more advertisement categories as the preferred categories for display in different streaming platforms and social media platforms. The Block option 404 enables the user to block one or more advertisement categories which are not displayed in different platforms to the user. The Apply option 406 enables the user to apply the preferences and block options on the selected advertisement categories. It will be apparent to a person skilled in the art that the options selected by the user are reflected in real-time across the streaming platforms, social media, and more accessed by the system 100.

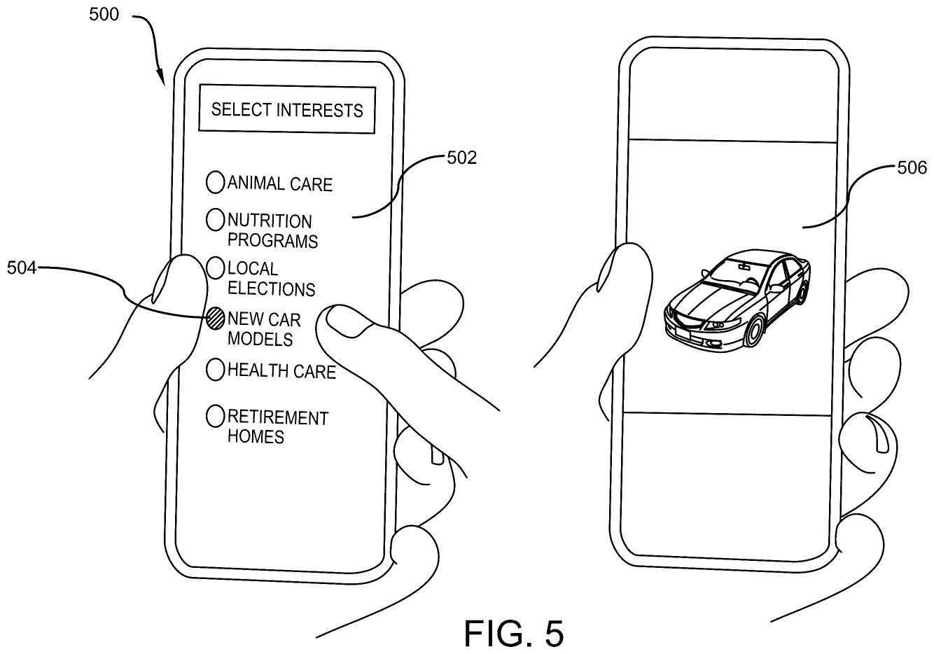

FIG. 5 illustrates a perspective view showing selection of an advertisement category by a user and an advertisement corresponding to the category being displayed to the user in accordance with the disclosed architecture. As illustrated, the interface 500 displays a list of advertisement categories 502 which are automatically created by the system 100 using the list of advertisements stored in the system 100. A user can select one or more categories from the list using the selection button 504 and advertisements from the selected categories are displayed to the user during appropriate ad times. For example, the advertisement 506 is displayed to the user in different streaming platforms wherein the advertisement 506 corresponds to the selected advertisement category 504. Similarly, the advertisements can be blocked from presenting to the user.

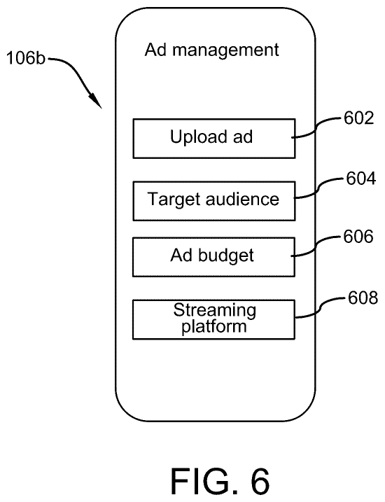

FIG. 6 illustrates a user interface displayed by the advertiser ad-filter application 102b for enabling advertisers to manage advertisements in accordance with one embodiment of the present invention. The user interface is displayed by the advertiser ad-filter application 102b and provides a plurality of options for enabling an advertiser to manage advertisement for wider reach. As illustrated, an Upload Ad option 602 enables the advertiser to upload one or more ads to the system 100 along with the metadata such as title, CCs, and more. The ad can be uploaded in different formats including but not limited to videos, GIFs, images, and more. A Target audience option 604 enables the advertiser to select target audience for the advertisements. The target audience can be chosen based on parameters such as age, geography, and more. The profile of the users and the parameters of the target audience option are matched to provide relevant ads to the users. An ad budget 606 is selected by the advertiser which enables the ad to run for a definite period of time to reach a threshold number of users. The budget 606 can be customized and may vary for different types of ads.

A plurality of streaming platforms can be associated with the system 100 for presenting advertisements to the users from different advertisers. Based on preferences of advertisers, an advertiser can choose one or more streaming platforms for displaying their ads using the Streaming platform option 608. The system 100 checks the content of the ads in accordance with the compliance regulations before activating the ads for display on different streaming platforms and more.

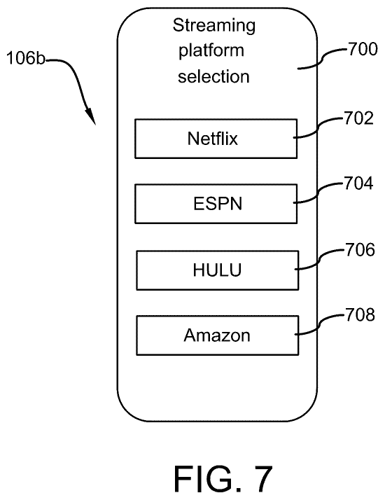

FIG. 7 illustrates an exemplary user interface displayed to an advertiser for selecting one or more streaming platforms or other social media platforms for selection in accordance with the disclosed structure. As illustrated, the interface 700 displays different platforms such as Netflix 702, ESPN 704, HULU 706, and Amazon 708 which can be chosen by the advertiser for displaying their ads. Any social media platform or any other platform can also be included and coupled to the system 100.

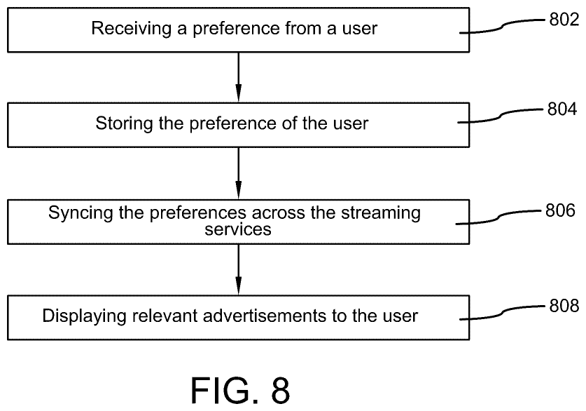

FIG. 8 illustrates a flow chart depicting a process of displaying relevant ads to a user based on the preferences in accordance with one embodiment of the present invention. Initially, at least one preference is received from the user by the system (Step 802) as described in FIG. 5. Then, the received preferences are stored in different databases of the server (Step 804). The stored preferences are automatically synced across the streaming services/social media accounts to which the user is subscribed or logged into (Step 806). Finally, the relevant advertisements based on the preferences of the user are displayed to the user (Step 808).

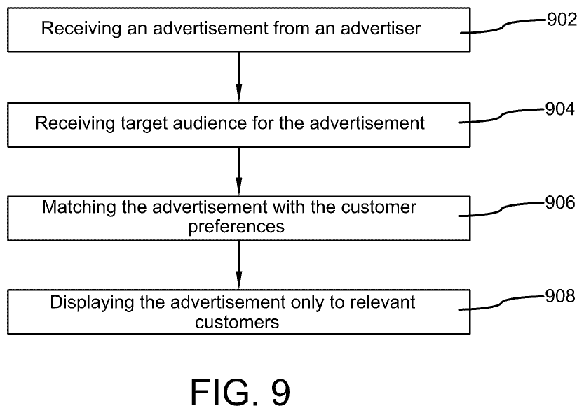

FIG. 9 illustrates a flow chart depicting a process of matching preferences of the users and advertisers to display relevant ads to customers in accordance with the disclosed structure. Initially, an advertisement is received from an advertiser as described in FIG. 6 (Step 902). Then, the target audience preferences are received from the advertiser (Step 904). Then, the targeting engine 124 matches the advertisement with the customer preferences which are included in the profile of the customer (Step 906). Finally, the advertisement is displayed only to relevant customers where the preferences of the advertiser and the customer matches (Step 908).

It is noteworthy to mention that the present invention provides a user with the ability to preview the advertisements prior to them being played on the user's device, while also having the option to not have them displayed on the device. This gives the user more control of what the individual or others, such as children, will be exposed to. It is also contemplated that the system could comprise a place where advertisers are able to see data from the consumer that represents where the most advertising interest is.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “advertisements management system”, “advertisements management and filtering system”, and “system” are interchangeable and refer to the advertisements management and filtering system 100 of the present invention.

Notwithstanding the forgoing, the advertisements management and filtering system 100 of the present invention can be of any suitable size and configuration as is known in the art without affecting the overall concept of the invention, provided that it accomplishes the above stated objectives. One of ordinary skill in the art will appreciate that the advertisements management and filtering system 100 as shown in the FIGS. are for illustrative purposes only, and that many other configurations of the advertisements management and filtering system 100 are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An advertisement filter application system comprising:
a user;
an advertiser;
an electronic user device;
a user advertisement filter application;
an advertiser advertisement filter application;
an electronic advertiser device;
a server;
a user management module;
a user database; and
a profile management module;
wherein said electronic user device is selected from the group consisting of a smartphone, a tablet, and a computer;
wherein said user advertisement filter application accessible by said user selected from the group consisting of a streaming service, and an e-sport service;
wherein said advertiser advertisement filter application installed in said electronic advertiser device of said advertiser;
wherein said user management module manages information of said user;
wherein said user database having stored a user profile, a preference, and a demographic criteria of said user and of said advertiser;
wherein said profile management module providing said user to update said user profile, said preference, and said demographic criteria;
wherein said profile management module having stored credential information of said user;
wherein said server having an advertisement management system including an advertisement database, a targeting engine, and an advertisement interface; and
further wherein said advertisement database having uploaded advertisements including corresponding metadata such as a title, a format, a category, a genre, and an age rating.

2. The advertisement filter application system of claim 1 further comprising an authentication module for managing a user login, a registration, and an authentication and comparing said user login, said registration, and said authentication of a plurality of received credentials from said users to a plurality of stored credentials for authentication.

3. The advertisement filter application system of claim 2, wherein said targeting engine matching said uploaded advertisements to said user profiles based on at least said preference and said demographic criteria set by said advertisers.

4. The advertisement filter application system of claim 3, wherein said targeting engine having a machine learning module having a plurality of learning algorithms to track past behavior selected from the group consisting of said preference, a dislike, and a streaming pattern of said user for autonomously recommending an advertisement category.

5. The advertisement filter application system of claim 4, wherein said advertisement interface uploads, categorizes, and manages said advertisements from said advertiser.

6. The advertisement filter application system of claim 5 further comprising an API module for communicating between said user advertisement filter application and said server.

7. The advertisement filter application system of claim 6, wherein said API module uploads said advertisements and said targeting criteria of said advertiser.

8. The advertisement filter application system of claim 7, wherein said API module interfaces with a network selected from the group consisting of a social media and a streaming service to communicate said preference of said user.

9. The advertisement filter application system of claim 8, wherein said user advertisement filter application having a user interface for signing up said user of said network.

10. The advertisement filter application system of claim 9 further comprising a block option for said user to block one or more said advertisement category.

11. An advertisement filter application system comprising:
a user;
an advertiser;
an electronic user device;
a user advertisement filter application;
an advertiser advertisement filter application;
an electronic advertiser device;
a server;
a user management module;
a user database; and
a profile management module;
wherein said electronic user device is selected from the group consisting of a smartphone, a tablet, and a computer;
wherein said user advertisement filter application accessible by said user selected from the group consisting of a streaming service, and an e-sport service;
wherein said advertiser advertisement filter application installed in said electronic advertiser device of said advertiser;
wherein said user management module manages information of said user;
wherein said user database having stored a user profile, a preference, and a demographic criteria of said user and of said advertiser;
wherein said profile management module providing said user to update said user profile, said preference, and said demographic criteria;
wherein said profile management module having stored credential information of said user;
wherein said server having an advertisement management system including an advertisement database, a targeting engine, and an advertisement interface;
wherein said advertisement database having uploaded advertisements including corresponding metadata such as a title, a format, a category, a genre, and an age rating;
wherein said targeting engine matching said uploaded advertisements to said user profiles based on at least said preference and said demographic criteria set by said advertisers; and
further wherein said targeting engine having a machine learning module having a plurality of learning algorithms to track past behavior selected from the group consisting of said preference, a dislike, and a streaming pattern of said user for autonomously recommending an advertisement category.

12. The advertisement filter application system of claim 11 further comprising an authentication module for managing a user login, a registration, and an authentication and comparing said user login, said registration, and said authentication of a plurality of received credentials from said users to a plurality of stored credentials for authentication.

13. The advertisement filter application system of claim 12, wherein said advertisement interface uploads, categorizes, and manages said advertisements from said advertiser.

14. The advertisement filter application system of claim 13 further comprising an API module for communicating between said user advertisement filter application and said server.

15. The advertisement filter application system of claim 14, wherein said API module uploads said advertisements and said targeting criteria of said advertiser.

16. The advertisement filter application system of claim 15, wherein said API module interfaces with a network selected from the group consisting of a social media and a streaming service to communicate said preference of said user.

17. The advertisement filter application system of claim 16 further comprising a machine learning module.

18. The advertisement filter application system of claim 17, wherein said user advertisement filter application having a user interface for signing up said user of said network.

19. The advertisement filter application system of claim 18 further comprising a block option for said user to block one or more said advertisement category.

20. An advertisement filter application system comprising:
a user;
an advertiser;
an electronic user device;
a user advertisement filter application;
an advertiser advertisement filter application;
an electronic advertiser device;
a server;
a user management module;
a user database; and
a profile management module;
wherein said electronic user device is selected from the group consisting of a smartphone, a tablet, and a computer;
wherein said user advertisement filter application accessible by said user selected from the group consisting of a streaming service, and an e-sport service;
wherein said advertiser advertisement filter application installed in said electronic advertiser device of said advertiser;
wherein said user management module manages information of said user;
wherein said user database having stored a user profile, a preference, and a demographic criteria of said user and of said advertiser;
wherein said profile management module providing said user to update said user profile, said preference, and said demographic criteria;
wherein said profile management module having stored credential information of said user;
wherein said server having an advertisement management system including an advertisement database, a targeting engine, and an advertisement interface;
wherein said advertisement database having uploaded advertisements including corresponding metadata such as a title, a format, a category, a genre, and an age rating;
wherein said targeting engine matching said uploaded advertisements to said user profiles based on at least said preference and said demographic criteria set by said advertisers;
wherein said targeting engine having a machine learning module having a plurality of learning algorithms to track past behavior selected from the group consisting of said preference, a dislike, and a streaming pattern of said user for autonomously recommending an advertisement category; and
further comprising a block option for said user to block one or more said advertisement category.
